(19) United States
(12) Patent Application Publication
(10) Pub. No.: US 2008/0022612 A1
(43) Pub. Date: Jan. 31, 2008

(54) APPARATUS FOR MAINTAINING THE STRUCTURAL INTEGRITY OF A PIPE PASSING THROUGH A BUILDING PARTITION

(76) Inventor: Thomas P. JONES, Easton, PA (US)

Correspondence Address: ROSSI, KIMMS & McDOWELL LLP., P.O. BOX 826, ASHBURN, VA, 20146-0826, US

(21) Appl. No.: 11/782,962

(22) Filed: Jul. 25, 2007

Related U.S. Application Data
(60) Provisional application No. 60/820,946, filed on Jul. 31, 2006.

(51) Int. Cl. E04C 2/52; F16L 57/00

(52) U.S. Cl. 52/220.8; 285/55

(57) ABSTRACT

A simple-to-use apparatus install around a pipe which passes through or under a building partition and maintains the structural integrity of the pipe in accordance with a typical building codes. More specifically, the apparatus preferably includes an inner sleeve composed of an elastomer (e.g. synthetic or natural rubber) or a foam-like material that surrounds the entirety of the portion of a pipe or conduit that passes through the building partition. The inner sleeve is entirely surrounded by an outer sleeve composed of a harder material than the inner sleeve. The inner sleeve and the outer sleeve can each be formed by extrusion, molding, or any other conventional manner. The inner sleeve maintains a circumferential spacing between a pipe passing through the apparatus at the outer sleeve thereby isolating the pipe from forces exerted by the building partition.

### CROSS-REFERENCE TO RELATED APPLICATION

This application is based on and claims priority from U.S. Provisional Application Ser. No. 60/820,946, filed on Jul. 31, 2006, the contents of which is incorporated by reference herein.

### BACKGROUND

The present invention relates to the protection of pipes or conduits, which pass through a building partition, in accordance with standard building codes.

Pipes passing through building partitions such as walls, floors, and the like are susceptible to structural damage and even breakage from forces exerted on the pipes from the building partition. For example, a pipe passing through a concrete wall can be damaged by forces exerted on the pipe as the foundation upon which the wall is built begins to settle. Accordingly, whenever pipes or conduits are installed or replaced in a building, special care needs to be taken to provide a proper support structure to relieve the stresses intrinsically created by a building partition upon such pipes.

In order to insure proper support is provided, building codes in many jurisdictions require that the portion of the pipe or conduit that passes through a building partition be protected with an isolation sleeve in order to maintain the pipe's structural integrity. The spacing between the sleeve and the pipe is filled with a packing material. In addition to isolating the pipe from forces exerted by the building partition, the use of the sleeve and packing material can also provide an additional benefit of reducing corrosion to the pipe. At present, the requirement for an isolation sleeve is achieved in a considerably ad hoc manner, often by utilizing spare materials at the job site. Subsequently, there is no uniform standard for meeting the requirements of a local building code as set forth above nor is there any standardized commercially available apparatus for accomplishing the isolation function.

In view of the above, it would be desirable to provide a simple-to-use apparatus that can be installed around a pipe which passes through or under a building partition and maintains the structural integrity of the pipe in accordance with typical building codes.

### SUMMARY OF THE INVENTION

The invention provides a simple-to-use apparatus that can be installed around a pipe which passes through or under a building partition and maintains the structural integrity of the pipe in accordance with typical building codes.

More specifically, the invention provides an apparatus that preferably includes an inner sleeve composed of an elastomer (e.g. synthetic or natural rubber) or a foam-like material that surrounds the entirety of the portion of a pipe or conduit that passes through the building partition. The inner sleeve is entirely surrounded by an outer sleeve composed of a harder material than the inner sleeve. The inner sleeve and the outer sleeve can each be formed by extrusion, molding, or any other conventional manner. The inner sleeve maintains a circumferential spacing between a pipe passing through the apparatus at the outer sleeve.

Further, at least one end flange can be provided which attaches to the building partition and covers one end of the inner and outer sleeve, thereby fixing the apparatus to the building partition. Optionally, a detachment portion can be provided on the end flange for detaching a detachment section from the flange in the event the end flange is desired to be shorter. Preferably, two end flanges are provided which attach to the building partition and each cover a respective end of the inner and outer sleeve.

Still further variations include: the use of at least one water proof gasket or the like that entirely surrounds the pipe and abuts one end of the inner and outer sleeve, and providing for the adjustment of the overall length of the apparatus by allowing the end flange to be moved with respect to the outer sleeve, in which case an o-ring is provided in a groove of the end flange in order to preserve the seal between the end flange and the outer sleeve.

Further modifications and variations will become apparent to those skilled in the art after reviewing the following detailed description of the preferred embodiments of the invention and the accompanying drawings.

### BRIEF DESCRIPTION OF THE DRAWINGS

A fuller understanding of the present invention will become apparent upon consideration of the following detailed description of the preferred embodiments of the invention when taken in connection with the accompanying drawings, wherein:

FIG. 1 is a perspective, cut-away view of an apparatus in accordance with the invention;

FIG. 2 is a cross-sectional view of the apparatus illustrated in FIG. 1 near one of its end flanges;

FIG. 3 is a cross-sectional view of an alternative configuration of the apparatus of FIG. 1 near one of its end flanges;

FIG. 4 is a cross-sectional view of an alternative embodiment of the apparatus in FIG. 1 wherein the end flange is extendable;

FIG. 5 is a front view of an end flange;

FIG. 6A is a side cut-away view of the outer sleeve;

FIG. 6B is a front view of the outer sleeve;

FIG. 7A is a side cut-away view of the inner sleeve; and

FIG. 7B is a front view of the inner sleeve.

### DETAILED DESCRIPTION OF THE PREFERRED EMBODIMENT

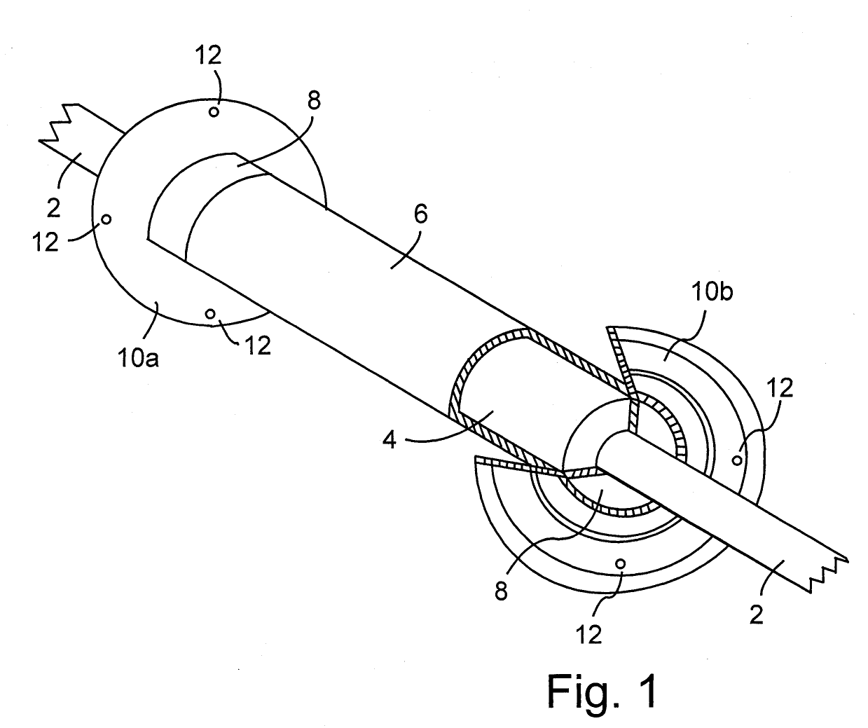

Referring to FIG. 1, an apparatus in accordance with the present invention includes an inner sleeve 4, preferably composed of an elastomer (e.g. natural or synthetic rubber) or a foam-like material, that is designed to surround the entirety of the portion of a pipe 2 that passes through or under a building partition. It should be noted that the term “pipe” is being utilized in the present description to include any form of piping or conduit needing to pass through a building partition. The inner sleeve 4 is entirely surrounded by an outer sleeve 6 which is composed of a harder material than the inner sleeve 4. Preferably, the inner sleeve 4 is composed of NEOPRENE (DuPont Trademark) and the outer sleeve 6 is composed of plastic such as polyvinyl chloride (PVC.) It should be understood that the inner sleeve 4 can be provided as a separate and distinct component, can be detachable affixed to the outer sleeve 6, or can be permanently affixed to the outer sleeve 6 (for example, by the use of an adhesive or by being co-extruded therewith). Further, the inner sleeve 4 and the outer sleeve 6 can each be formed by extrusion, molding, or other conventional means.

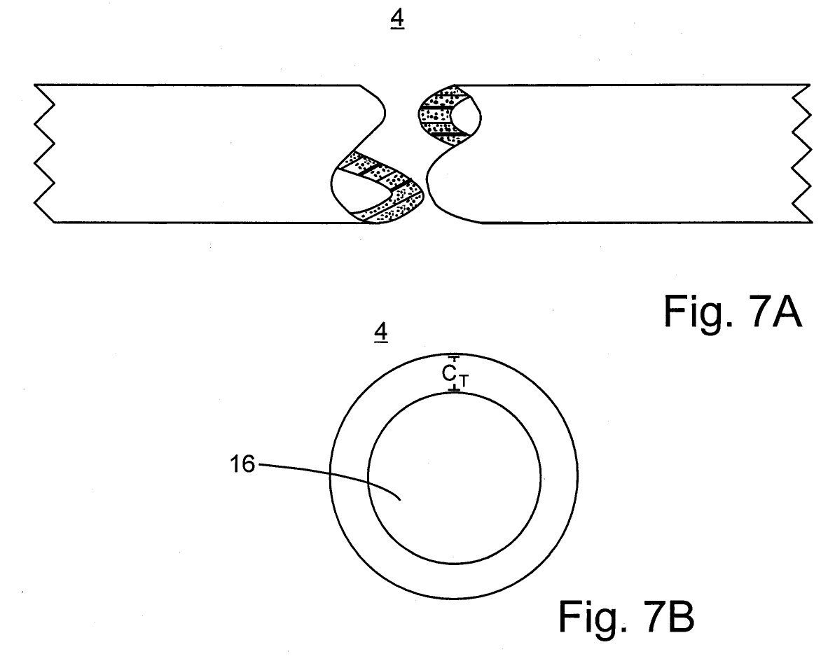

Referring to FIG. 7B, the inner sleeve 4 is formed so that it maintains a predetermined circumferential spacing C_{T} between the outer sleeve 6 and a pipe passing through a core opening 16 of the inner sleeve 4. It should be understood that a core opening 16 need not be a round opening, but can be a slit or an opening of any size and shape that permits the pipe to pass through the inner sleeve 4. The circumferential spacing C_{T} insures that a pipe passing through the inner sleeve is sufficiently isolated from the outer sleeve 6 to prevent any significant transfer of force from the wall partition to the pipe. The actual spacing will vary depending on the particular application, namely, the type of pipe being protected, and/or variations in local building code requirements.

A further embodiment of the present invention, also illustrated in FIG. 1, incorporates the use of an end flange. For example, at least one end flange 10a is provided which can be attached to a building partition by use of an adhesive or by way of a screw, nail, bolt, or the like applied to one or more holes 12 provided in the end flange 10a. It should be understood that one or more of the holes 12 can be threaded in order to facilitate such attachment. Upon attachment, the end flange 10a covers an end of the inner sleeve 4 and the outer sleeve 6. Preferably, an additional end flange 10b which covers the opposite end is provided. Optionally, at least one water proof gasket 8 or the like is provided that entirely surrounds the pipe and abuts one end of the inner and outer sleeve.

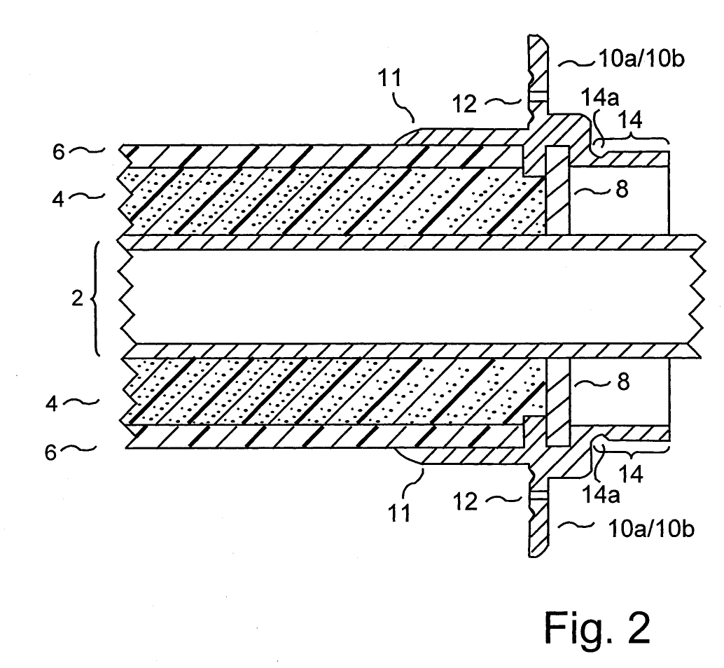

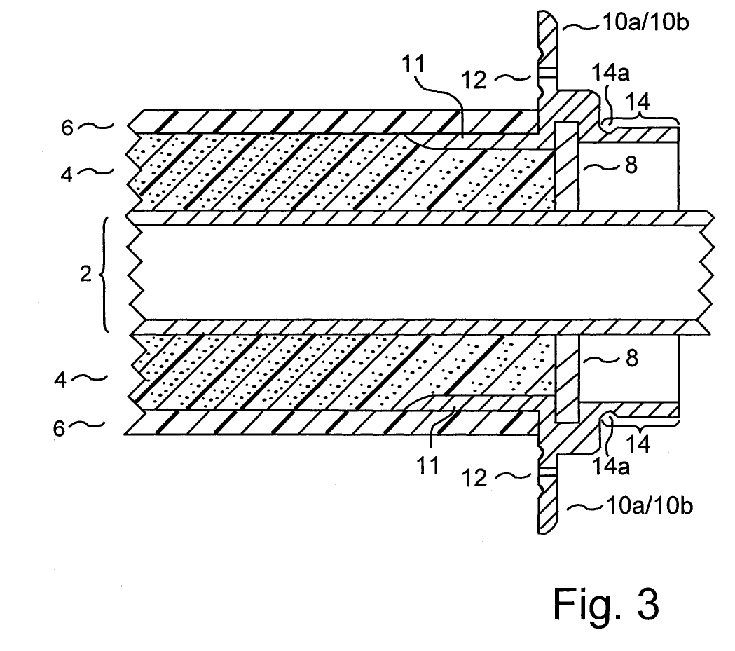

FIG. 2 illustrates a cross-sectional view of the invention near one of its end flanges as described previously with respect to FIG. 1. In the illustrated embodiment, the end flange 10a and/or 10b includes a salient portion 11 which covers the outer sleeve 6. In an alternative configuration as shown in FIG. 3, the outer sleeve 6 covers the salient portion 11 of the end flange 10a/10b. In each case, the end flange 10a/10b can also include a detachment portion 14a for detaching a detachment section 14 if desired in order to adjust the overall length of the device in accordance with particular applications. For example, in the case of a pipe coming up through a floor partition of a building, it is desirable that the flange extend beyond the floor surface so that water accumulating on the floor will not enter the flange opening. Alternatively, in the case of a pipe passing through a vertical wall, it is desirable that the flange be as flush as possible with the wall surface. The embodiments illustrated in FIGS. 2 and 3 are otherwise constructed in the same manner as illustrated in FIG. 1 and as described with respect thereto.

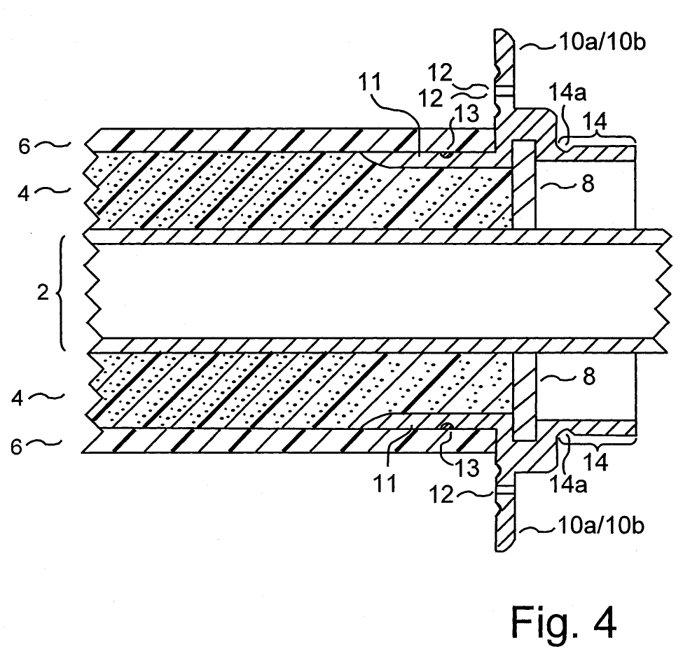

FIG. 4 illustrates yet another embodiment of the present invention. In some cases, it may be necessary to extend the end flange 10a/10b so that it can reach and be attached to the periphery of a building partition. Should this be desired, the end flange 10a/10b can slide back and forth in a parallel manner with respect to the outer sleeve 6 at the salient portion 11 in order to provide some adjustment of the overall device. In order to preserve the seal between the salient portion 11 and the outer sleeve 6, an o-ring 13 is provided in a groove of the salient portion 11.

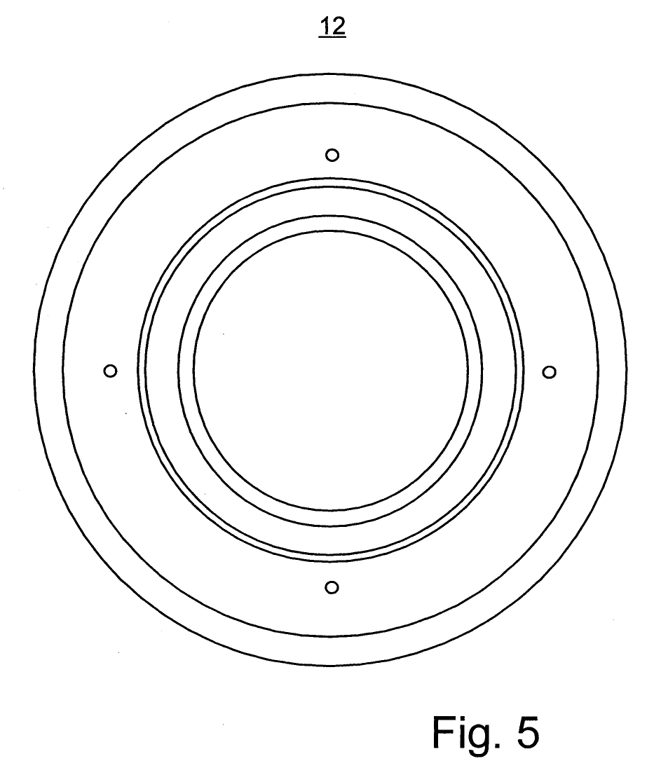

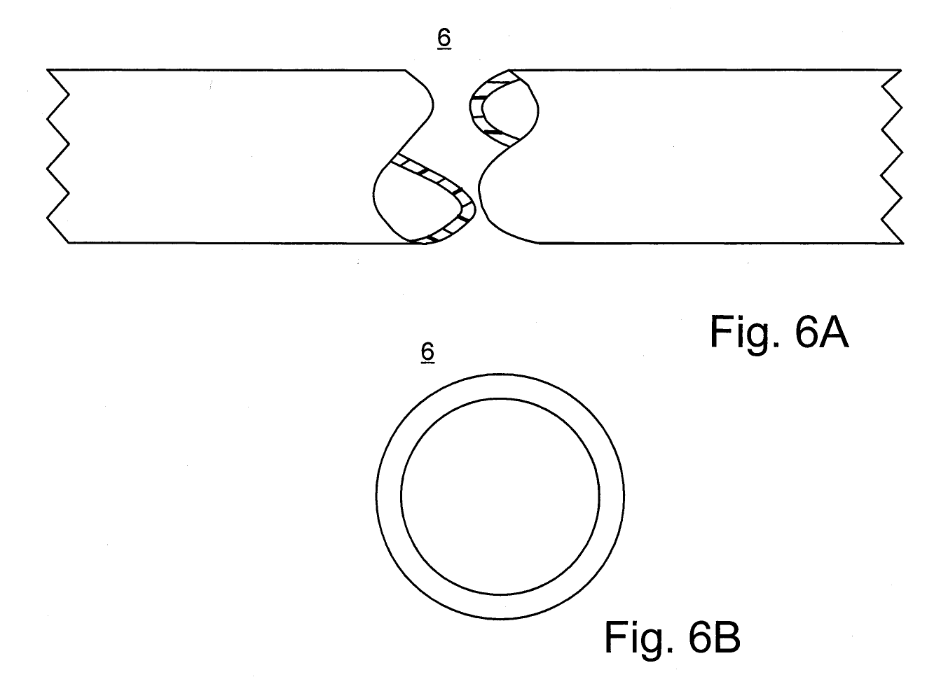

FIG. 5 illustrates a front view of an end flange of the invention. The end flange is manufactured to conform to the particular dimensions of the pipe which it will be installed on. It should therefore be appreciated that the invention can be produced for any number of standard pipes so that it can be easily installed at a job site. Hence, the outer sleeve and the inner sleeve have dimensions which vary according to any number of standard pipe sizes. The invention may also vary depending on the dimensions of a building partition for which the invention is to be installed on. Referring to FIGS. 5A and 5B, it should be understood that the length, the height, diameter, and thickness of the outer sleeve 6 vary in order to conform to any number of standardized pipes or conduits and building partitions. This also holds true for the inner sleeve 4 pictured in FIGS. 6A and 6B and the gasket 8 pictured in FIGS. 1-4.

As should be obvious from the above description, the invention can be easily installed at a job site in order to protect a pipe passing through a building partition from the stresses of the partition and corrosion in accordance with local building codes. To install, a worker simply inserts the invention around a pre-installed pipe and within a building partition. Next, the worker may attach at least one end flange to the building partition so that the end flange covers one end of the inner and outer sleeves. Alternatively, if the pipe has yet to be installed, a worker can first install the apparatus as described above and then slide a pipe through the apparatus. In each case, a worker may additionally detach the detachable portion of the end flange as previously described.

The invention has been described with reference to certain preferred embodiments thereof. It will be understood, however, that modifications and variations are possible within the scope of the appended claims. As just one example, the apparatus can be provided with telescoping portions of at least one of the outer sleeve or the inner sleeve in order to allow for length adjustment. Still further, the inner sleeve may be made of any material that provides sufficient isolation to prevent detrimental forces to be transmitted from the building partition to the pipe passing through the inner sleeve. Further, as with the description, the term “pipe” in the claims is intended to cover any form of pipe, conduit, etc. passing through a building partition.

What is claimed is:

1. An apparatus for maintaining the structural integrity of a pipe that passes through a building partition, comprising:
an inner sleeve including a core opening; and
an outer sleeve that surrounds the inner sleeve;
wherein the inner sleeve is sized to fit within the outer sleeve and to maintain a predetermined circumferential spacing between the outer sleeve and a pipe passing through the core opening.

2. The apparatus for maintaining the structural integrity of a pipe that passes through a building partition according to claim 1, wherein the outer sleeve is harder than the inner sleeve.

3. The apparatus for maintaining the structural integrity of a pipe that passes through a building partition according to claim 2, wherein the outer sleeve is made of plastic.

4. The apparatus for maintaining the structural integrity of a pipe that passes through a building partition according to claim 3, wherein the plastic is Polyvinyl Chloride.

5. The apparatus for maintaining the structural integrity of a pipe that passes through a building partition according to claim 2, wherein the inner sleeve is made of an elastomer.

6. The apparatus for maintaining the structural integrity of a pipe that passes through a building partition according to claim 5, wherein the elastomer is NEOPRENE.

7. The apparatus for maintaining the structural integrity of a pipe that passes through a building partition according to claim 1, further comprising at least one attachment mechanism that covers an end of the inner sleeve and the outer sleeve and is adapted to attach to a building partition.

8. The apparatus for maintaining the structural integrity of a pipe that passes through a building partition according to claim 7, wherein the attachment mechanism is an end flange.

9. The apparatus for maintaining the structural integrity of a pipe that passes through a building partition according to claim 8, wherein the end flange includes at least one attachment hole.

10. The apparatus for maintaining the structural integrity of a pipe that passes through a building partition according to claim 9, wherein the hole is threaded.

11. The apparatus for maintaining the structural integrity of a pipe that passes through a building partition according to claim 7, further comprising a gasket that covers an end portion of the inner sleeve.

12. The apparatus for maintaining the structural integrity of a pipe that passes through a building partition according to claim 8, wherein the outer sleeve covers a salient portion of the end flange.

13. The apparatus for maintaining the structural integrity of a pipe that passes through a building partition according to claim 8, wherein a salient portion of the end flange covers the outer sleeve.

14. The apparatus for maintaining the structural integrity of a pipe that passes through a building partition according to claim 8, wherein the end flange includes a detachment portion for detaching a detachment section from the end flange.

15. The apparatus for maintaining the structural integrity of a pipe that passes through a building partition according to claim 8, wherein the end flange includes a salient portion and further comprising a seal that fits within a groove provided in the salient portion.
